(19) United States
(12) Patent Application Publication
(10) Pub. No.: US 2006/0015867 A1
(43) Pub. Date: Jan. 19, 2006

(54) Business productivity pack

(76) Inventors: Bernhard Drittler, Walldorf (DE); Joerg Flender, Wiesloch (DE); Dietmar Saddei, Sinsheim-Reihen (DE)

Correspondence Address: KENYON & KENYON, ONE BROADWAY, NEW YORK, NY, 10004, US

(21) Appl. No.: 11/093,657

(22) Filed: Mar. 29, 2005

Related U.S. Application Data
(60) Provisional application No. 60/569,242, filed on May 10, 2004.
(60) Provisional application No. 60/574,992, filed on May 28, 2004.
(60) Provisional application No. 60/575,359, filed on Jun. 1, 2004.

(51) Int. Cl. G06F 9/445

(52) U.S. Cl. 717/174

(57) ABSTRACT

A method for updating a business software system is provided that includes installing a support package in the business software system and providing an option to an administrator to activate at least one new functionality in the business software system continuously after the installing operation. The support package may be adapted to not provide the new functionality until activated by the administrator. A business software system is provided that includes a support package adapted to provide at least one new functionality upon being activated by an administrator of the business software system. The support package is adapted to not provide the new functionality until activated by the administrator. The support package provides an option to the administrator to activate the new functionality continuously after the installing operation. A method for updating a business software system is provided.

### CROSS-REFERENCE TO RELATED APPLICATIONS

The present invention claims priority to U.S. Provisional Application No. 60/569,242, filed on May 10, 2004, U.S. Provisional Application No. 60/574,992, filed on May 28, 2004, and U.S. Provisional Application No. 60/575,359, filed on Jun. 1, 2004, which are expressly incorporated herein in their entirety.

### BACKGROUND

The present invention relates to computer software. More particularly, the present invention relates to a method of updating business software.

Upgrading a business software application may be an expensive, time-consuming, and frustrating experience. Though new business software may provide additional functionality, the risk of down-time during an upgrade and the potential for lower productivity during adaptation to the new functionalities may prevent some users from deciding to upgrade. Additionally, training new users and/or training experienced users with new functionalities may require and an extensive and expensive training effort.

Software updates conventionally load automatically, overwrite existing files, and/or change existing functionalities. Therefore, there is a need for a software package that provides new functionalities without inconveniencing the user.

### BRIEF DESCRIPTION OF THE DRAWINGS

FIG. 1 is a schematic diagram illustrating an exemplary system according to the present invention.

FIG. 2 is a flowchart illustrating an exemplary method according to the present invention.

FIG. 3 is a schematic diagram of an exemplary folder system for an exemplary embodiment according to the present invention.

### DETAILED DESCRIPTION

A method for updating a business software system is provided that includes installing a support package in the business software system and providing an option to an administrator to activate at least one new functionality in the business software system continuously after the installing operation. The support package may be adapted to not provide the new functionality until activated by the administrator.

In the method, installing the support package may not modify a user interface of the business software system and installing the support package may not alter existing roles of the business software system.

The method may further include providing to the administrator a menu option adapted to allow the administrator to select the new functionality.

The method may further include selecting by the administrator the new functionality. The method may further include providing a further option to the administrator to deactivate the new functionality continuously after the selecting operation. In the method the business software package may include one role with one role-specific view and at least one user interface. In the method the new functionality includes a new role, a new role-specific view, and/or a new user interface.

In the method, installing the support package may provide at least one additional functionality for an existing role of the business software system.

The method may further include providing another option to the administrator to activate the new functionality and/or the additional functionality for the existing role and/or a new role of the business software system. The new functionality and/or the additional functionality may not be activated for at least one further role.

In the method, the support package may include new objects and/or new table entries.

In the method, the support package may include a maintenance package for the business software system and the maintenance package of the support package may install automatically in the business software system.

In the method, the support package does not include any of modifications to existing objects, changes to an existing database, new data base tables, new metadata, and extensions of the business software system.

A business software system is provided that includes a support package adapted to provide at least one new functionality upon being activated by an administrator of the business software system. The support package is adapted to not provide the new functionality until activated by the administrator. The support package provides an option to the administrator to activate the new functionality continuously after the installing operation.

In the system, the system may provide to the administrator a menu option adapted to allow the administrator to select the new functionality.

In the system, the business software system may include a role with a role-specific view and a user interface. The business software system may include the new functionality includes at least one of a new role, a new role-specific view, and a new user interface.

In the system, installing the support package may not alter existing roles of the business software system.

In the system, installing the support package may provide additional functionality to an existing role of the business software system.

In the system, the support package may include new objects and/or new metadata and/or new table entries.

In the system, the support package may include a maintenance package for the business software system. In the system, the maintenance package of the support package may install automatically in the business software system.

A method for updating a business software system is provided that includes installing a support package in the business software system. The support package is adapted to provide at least one new functionality upon being activated by an administrator of the business software system. The support package is adapted to not provide the new functionality until activated by the administrator.

The present invention may provide new business content without an upgrade of the application. An exemplary embodiment of the present invention may treat content development as a non-modifying content package development for a CRM server, data warehouse content (also referred to as BW content) and CRM Portal content (which typically contains roles like a sales representative). Activation of the new content for the end user may be demand driven at customer side. This activation may be performed through an administration for portal content, applications/views and/or BW content. CRM is a customer relationship management system. The applications for the CRM server are typically WEB based. In the SAP environment those applications are typically built with BSP. BSP stands for Business Server Pages, which is one way to dynamically generate HTML pages (based on SAP technology). Views on top of those applications allow a role (also referred to herein as a user group, for instance a sales representative) specific adaptation of those applications, which could reduce or extend the fields available for the users of that role. Depending on the design, views of those applications can be used in different roles.

In the present invention, a support package may be applied to a system. The new functionality provided by the support package may remain inactivated or dormant until an administrator activates the new functionality. The administrator may activate the new functionality at any time after the installation of the support package, and also may deactivate the new functionality at any time after activation. Additionally, the administrator may selectively activate the new functionality for particular user groups. These user groups may be identified in a role-specific application by their designated roles. In parallel the old functionality still can be used by other user groups or the old functionality can be re-invoked for the selected user group if required. Activation of new functionality requires no additional installation, merely the activation by the administrator.

Backend objects may be managed by a backend manager. By placing the new package adjacent and/or in addition to the existing package, the portal may allow communication between the old and new content packages. A support package may include repairs and/or modifications of existing functionality, and/or in an exemplary embodiment of the present invention, additional new functionality that may or may not be selected for operation by an administrator. The new functionality may include a new user interface including new views, new functions for existing applications including role-specific views, and/or new applications and new roles.

For example, an existing CRM system may not include a role for a sales representative. Users of the system may use an alternative role for users of this type. Using an exemplary embodiment of the present invention, a software package may allow the administrator to select a sales rep role (or any other offered role) and activate it in the system. The new role may include a user specific interface including role specific views that allow the sales representative to more easily fulfill their function.

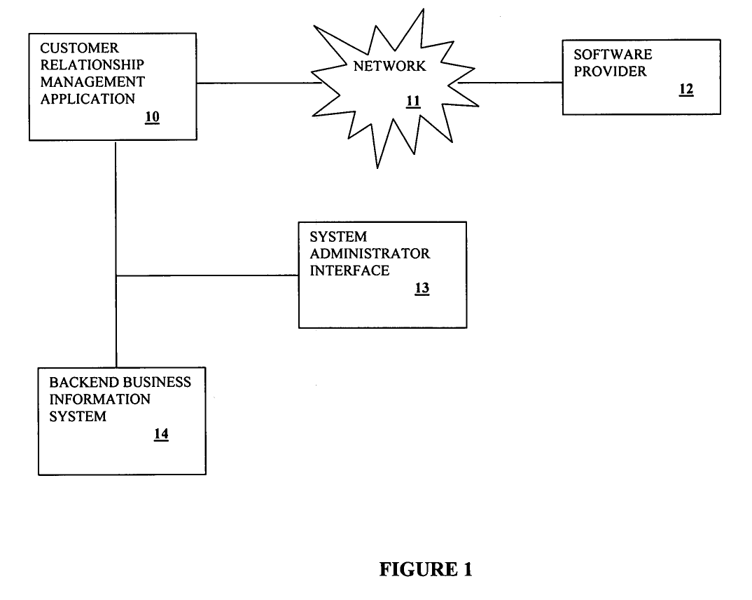

FIG. 1 shows an exemplary system according to the present invention. The invention may be valid for all types of IT systems, which may be shipped as standard software. In FIG. 1, for example, a customer relationship management application 10 is connected to network 11. Network 11 may be the internet, a local area network (LAN), or any other appropriate network. Network 11 is connected to software provider 12, which may provide business applications, upgrades, and/or ongoing technical support. Also connected to customer relationship management application 10 is system administrator interface 13 and backend business information system 14. System administrator interface 13 may provide an interface for a super user, administrator, or other user to control the functioning of the system. Backend business information system 14 may provide a business database and/or a business data warehouse. Customer relationship management application 10 may access backend business information system 14 to provide data to run customer relationship management application 10.

Software provider 12 may provide a content package via network 11 to customer relationship management application 10. The content package may include various non-modifying content for customer relationship management application 10. The content package may also include new functionality for existing components of customer relationship management application. The new functionality provided by the content package may not be available unless selected by a system administrator via system administrator interface 13 for installation. After installation, the new functionality provided by the content package to customer relationship management application 10 may allow a new and/or different accessibility to data in backend business information system 14.

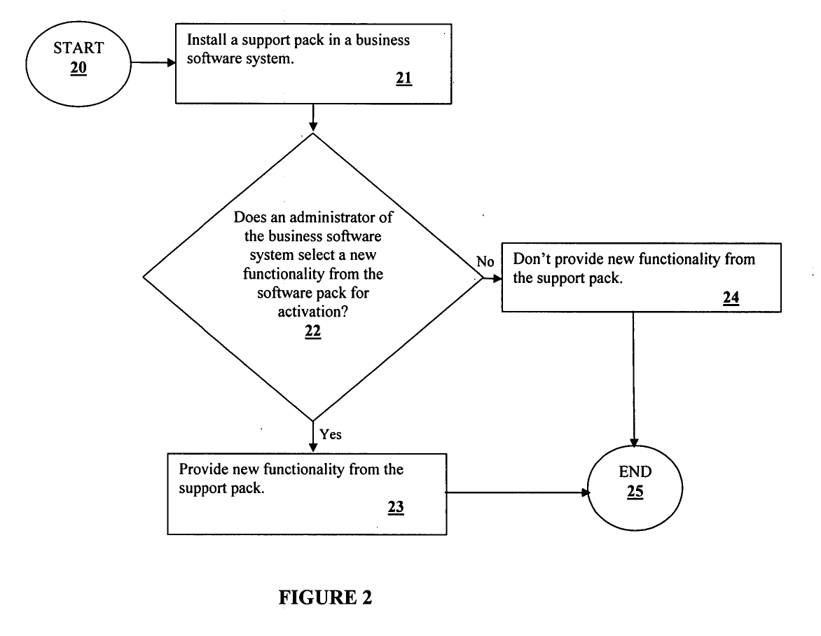

FIG. 2 shows an exemplary method according to the present invention. The flow in FIG. 2 begins in start circle 20 and proceeds to action 21, which indicates to install a support pack in a business software system. From action 21, the flow proceeds to decision 22, which asks whether an administrator of the business software system has selected a new functionality from the software pack for activation. If the response to decision 22 is in the affirmative, the flow proceeds to action 23, which indicates to provide new functionality from the support pack. From action 23, the flow proceeds to end circle 25. If the response to decision 22 is in the negative, the flow proceeds to action 24, which indicates to not provide new functionality from the support pack. From action 24, the flow proceeds to end circle 25.

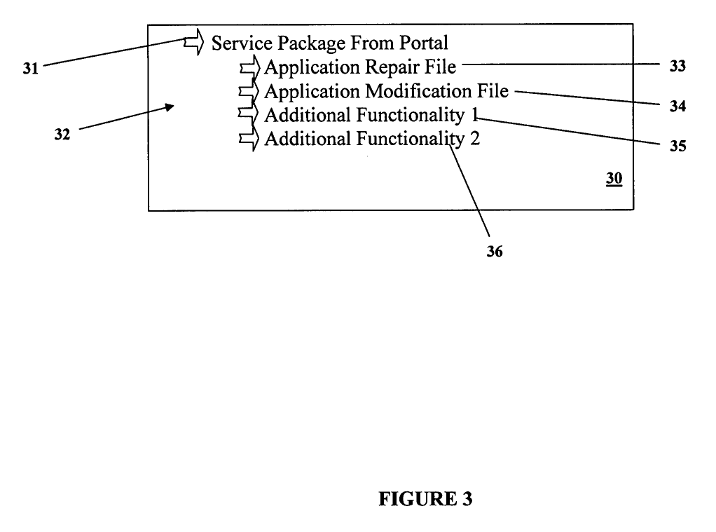

FIG. 3 is a schematic diagram of folder system 30 for an exemplary embodiment according to the present invention. Folder system 30 may be accessed by an administrator through a portal on a network, for instance the internet. Folder system 30 includes folder 31 entitled “Service Package From Portal”. Folder 31 includes files structure 32, which is composed of files 33, 34, 35, 36. File 33, entitled “Application Repair File”, may include a software patch to correct or improve an software system. File 34, entitled “Application Modification File”, may also include a software patch to correct or improve the software system. File 35, entitled “Additional Functionality 1”, may include new functionality for the software system. File 36, entitled “Additional Functionality 1”, may include further new functionality for the software system. Folder system 30 accessed via a portal by an administrator of a software system may allow the administrator to more effectively control updates to a software system.

If an administrator does not want to add functionality 1 but does want to add functionality 2, then the administrator may update the software accordingly, and vice versa. Additionally functionality 1 and functionality 2 may be designed to not interfere with existing functionalities of the system. For instance, in the context of roles, a new role may be added to an existing software package via folder system 30. An administrator may or may not decide to add a new “sales representative” role embodied in functionality 1, including new role-specific views. Likewise, an administrator may or may not decide to add a new “account manager” role embodied in functionality 2, including other, new role-specific views.

An exemplary embodiment of the present invention may treat content development within the CRM Server as a non-modifying, content package development. In order to avoid an additional support line, this content package may be shipped together with a standard customer relationship management software package for bug fixing.

An advantage of the present invention may include minimizing the disturbance to a customer. Extension within a content edition may not affect scenarios, processes, and user interfaces of an existing business software application. Additionally, no new end user training and no upgrade customizing may be required. The usage of the new roles, functionality, etc. could require some end user training, but this could be planned since the activation can be done at any time which is suitable.

One consequence of the present invention may be that modifications on existing objects during development of the new content may not be allowed. In particular, changes of existing mete data definitions and/or database tables may not be allowed.

Activation of the new content for the end user may be demand driven at the customer side. The customer may utilize the appropriate administration tools to modify portal content, applications, views, and business warehouse content. In case of content for mobile devices like laptops, PDAs, etc. the customer may utilize a so called mobile workbench for mobile content.

There may be various development rules for a content package according to the present invention for a customer relationship management server. For instance, only new objects in new packages (package means here an organizational element to group software to be shipped) and new metadata and new table entries may be allowed. Additionally or alternatively, new data base tables may not be allowed. For each development area, specific rules may be defined to ensure this way of software shipment.

An exemplary embodiment of the present invention may separate a development system and a testing system for this feature pack (also called content package). New software packages may be named and users may be dedicated.

A following release of the software may include the functionality of the content package as some kind of retrofit. Integrating a content package upgrade may avoid the requirement of an additional support line.

Extraction of data warehouse content (also referred to as BW content) may be necessary in case of new data warehouse content or reports.

Portal content development including maintenance of object links may be restricted to a small community within a CRM. Current roles may be added to the new content in a Business Pack assembly process to ensure that these roles are unchanged. Changes of existing object link table entries will be monitored and changes may be limited.

Cross system checks between a development system and a feature pack development system may be necessary to prevent changes on existing metadata and/or table entries.

Customers may be informed in a content package that the old roles will be deleted within the next release, thereby providing warning to customer-developers. This information may be provided to customers so that they could plan to develop on top of new roles in subsequent editions of the application.

In an exemplary embodiment of the present invention, there may be no change of an existing user interface with a new content edition. In particular, there may be no modification of existing objects in the software application. Only new objects may be allowed, as well as only new applications. Additionally, new views for existing applications and new model access classes may be allowed.

Namespaces may be defined for new objects (with long text, owner, source view and leading role). Namespace may prevent overwriting of existing functionalities by providing space in current iterations of a software package for later additions of names and corresponding functionality. New views may be provided, and some fields may be removed. New views may be added. New fields, new tab groups and new toolbars may also be possible.

New applications and/or new views may be possible without any interference to existing user interfaces.

A content edition on top of existing functionality according to an exemplary embodiment of the present invention may impose restrictions due to the fact that all existing functionality has to fully work after migration to the content add-on. Additionally, obsolete objects may have to be deleted as part of a later clean-up and/or redesign of the application.

Several conditions may preferably preexist to facilitate the present invention. An exemplary embodiment of the present invention may be adapted to work with a business software system based on a customer relationship management system (also referred to herein as a CRM, for instance SAP CRM 4.0). This may ensure that no new release of CRM may be required. Compliance to selected product standards of SAP for CRM 4.0 may be enabled. But requirements in the people-centric area may lead to new content within the CRM server due to: basics for portal content, for instance object links; new CRM applications/views; new data warehouse extractors; and new customizing.

Basic assumptions for a content edition according to an exemplary embodiment of the present invention may include the feature that shipped processes and functionality have to remain fully functional. In other words, there may need to be zero migration effort for the upgrade customer (for example, effort may only be required for activation of new pieces). Additionally, existing training material and documentation may remain valid. No retraining effort may need to be required for the upgrade customer for already-shipped functionality. All developments may need to fully comply with product standards.

These assumptions may imply the following technical restrictions: development may need to define specific rules to ensure that nothing old has been changed. The rules chosen for the content package of CRM 4.0 have included: no changes to existing objects (coding, metadata, etc.) may be allowed; no major redesigns of processes, or no changes on existing roles may be allowed; development only in new packages may be allowed; and no redesign of existing business processes and scenarios in a solution manager and/or customization tool may be allowed.

One specific rule as an eamxple for the SAP CRM content package was a namespacing definition to allow only new functionality or content to be added without overwriting existing functions or files.

Some other rules for development of a content addition according to an exemplary embodiment of the present invention may include: only creating new data warehouse extractors; all objects in new packages; extractor function modules in new function groups only, including new coding objects new classes, new methods, new procedures, and new screens; and no changes to existing extractors.

Some other rules for development of a content addition according to an exemplary embodiment of the present invention may include: pure DataSource meta data for data warehouse content changes (without changes of the coding behind) may be allowed because these may have to be activated by the customer before they take effect. For example, field released for filtering and field made visible for data warehouses.

Some additional rules are that new business content for data warehouse content may be allowed (all object types), and no changes of existing views and/or web templates may be allowed.

One benefit of an exemplary system according to the present invention may be that a productive CRM 4.0 customer may not be affected. Extension within the content edition may not affect scenarios, processes and user interfaces of existing CRM 4.0 content (in other words, there may be no side effects). No new end user training may be required. Additionally, there may be no upgrade customizing.

Another consequence of upgrading via a content package may be that modifications on existing objects may not be allowed. In particular changes of existing database tables and data conversions of existing customer data may not be allowed. Extensions and/or a series of extensions may be provided that may be applied on top of a customer relationship management application, for instance SAP CRM 4.0. These upgrades may be provided without the cost of a release upgrade. Additionally these additions may be fully upgradeable to future releases of a customer relationship management application.

While the present invention has been described in connection with the foregoing representative embodiment, it should be readily apparent to those of ordinary skill in the art that the representative embodiment is exemplary in nature and is not to be construed as limiting the scope of protection for the invention as set forth in the appended claims.

What is claimed is:

1. A method for updating a business software system, comprising:
installing a support package in the business software system; and
providing an option to an administrator to activate at least one new functionality in the business software system continuously after the installing operation;
wherein the support package is adapted to not provide the new functionality until activated by the administrator.

2. The method of claim 1, wherein:
installing the support package does not modify a user interface of the business software system; and
installing the support package does not alter existing roles of the business software system.

3. The method of claim 1, further comprising providing to the administrator a menu option adapted to allow the administrator to select the new functionality.

4. The method of claim 3, further comprising selecting by the administrator the new functionality.

5. The method of claim 4, further comprising providing a further option to the administrator to deactivate the new functionality continuously after the selecting operation.

6. The method of claim 3, wherein:
the business software package includes at least one role with at least one role-specific view and at least one user interface; and
the new functionality includes at least one of a new role, a new role-specific view, and a new user interface.

7. The method of claim 1, wherein installing the support package provides at least one additional functionality for an existing role of the business software system.

8. The method of claim 7, further comprising:
providing another option to the administrator to activate at least one of the new functionality and the additional functionality for at least one of the existing role and a new role of the business software system;
wherein the at least one of the new functionality and the additional functionality is not activated for at least one further role.

9. The method of claim 1, wherein the support package includes at least one of new objects and new table entries.

10. The method of claim 1, wherein:
the support package includes a maintenance package for the business software system; and
the maintenance package of the support package installs automatically in the business software system.

11. The method of claim 1, wherein the support package does not include any of modifications to existing objects, changes to an existing database, new data base tables, new metadata, and extensions of the business software system.

12. A business software system, comprising:
a support package adapted to provide at least one new functionality upon being activated by an administrator of the business software system, the support package adapted to not provide the new functionality until activated by the administrator;
wherein the support package provides an option to the administrator to activate the new functionality continuously after the installing operation.

13. The system of claim 12, wherein the system provides to the administrator a menu option adapted to allow the administrator to select the new functionality.

14. The system of claim 12, wherein:
the business software system includes at least one role with at least one role-specific view and at least one user interface; and
the new functionality includes at least one of a new role, a new role-specific view, and a new user interface.

15. The system of claim 12, wherein installing the support package does not alter existing roles of the business software system.

16. The system of claim 12, wherein installing the support package provides at least one additional functionality to an existing role of the business software system.

17. The system of claim 12, wherein the support package includes at least one of new objects and new table entries.

18. The system of claim 12, wherein the support package includes a maintenance package for the business software system.

19. The system of claim 12, wherein the maintenance package of the support package installs automatically in the business software system.

20. A method for updating a business software system, comprising:
installing a support package in the business software system, the support package adapted to provide at least one new functionality upon being activated by an administrator of the business software system, the support package adapted to not provide the new functionality until activated by the administrator.
